(19) United States
(12) Patent Application Publication
(10) Pub. No.: US 2026/0134396 A1
(43) Pub. Date: May 14, 2026

(54) METHODS, SYSTEMS, AND MEDIA FOR CONNECTING CONTRACTORS TO EMPLOYERS

(71) Applicants: Michael Huffman, Austin, TX (US); Erin Morgan, Austin, TX (US); Daniela Ghinchevici, Austin, TX (US)

(72) Inventors: Michael Huffman, Austin, TX (US); Erin Morgan, Austin, TX (US); Daniela Ghinchevici, Austin, TX (US)

(21) Appl. No.: 18/946,092

(22) Filed: Nov. 13, 2024

(51) Int. Cl. G06Q 10/1053; G06Q 20/40; G06Q 30/018; G06Q 30/0282; G06Q 40/12

(52) U.S. Cl. CPC G06Q 10/1053; G06Q 20/40; G06Q 30/018; G06Q 30/0282; G06Q 40/123

(57) ABSTRACT

The disclosed systems, methods, and media for connecting contractors to employers can receive, from a contractor user device, contractor registration data; query state license databases to verify the contractor registration data; query background check databases to determine if any criminal record data exists for a first contractor; receive, from an employer user device, first job position data; receive, from the contractor user device, a request to search for jobs within a first geographical region; in response, receive, from the contractor user device, a request to be hired for the first job position; compare the contractor registration data with the first job position data; in response, send, to the employer user device, a request to hire the first contractor for the first job position; receive, from the employer user device, an acceptance of the request; and in response, initiating payment of at least one insurance premium.

### TECHNICAL FIELD

Embodiments disclosed herein can relate to methods, systems, and media for connecting contractors to employers.

### BACKGROUND

Employers commonly offer full-time employment to attract the best workers, and as means of building an in-house team in order to be able to provide a service in a timely manner. However, such full-time employment can be overly expensive, and it can result in employee paid time that includes unproductive time, as full time employment is not very adaptable to demand times and quiet times for a company and business. And most of the time it also means workers also don't have full flexibility when they accept full time employment, which is an unfavorable scenario especially in a post-pandemic employment market scene.

There is a need for methods, systems, and media for connecting contractors to employers so that employers can better find independent contractors to fulfill the needs of the employer. In this way, full-time employment can be made entirely optional.

### SUMMARY

This summary is provided to introduce a variety of concepts and/or aspects in a simplified form that is further disclosed in the detailed description, below. This summary is not intended to identify key or essential inventive concepts of the claimed subject matter, nor is it intended for determining the scope of the claimed subject matter.

A system of one or more computing devices can be configured to perform particular processes by virtue of having software, firmware, hardware, or a combination thereof installed on the system that in operation causes or cause the system to perform the processes.

In some embodiments, a system for connecting contractors to employers can include memory and one or more processors operably coupled to the memory, the one or more processors being configured at least to: receive, from a first user device associated with a first contractor, contractor registration data of the first contractor, the contractor registration data including first contractor location data and first job experience data; query one or more state license databases to verify at least a portion of the contractor registration data; query one or more background check databases based at least on the contractor registration data to determine that no criminal record data was found for the first contractor; receive, from a second user device associated with a first employer, first job position data including first job location data, first job compensation data, and first job requirement data for a first job position; receive, from the first user device associated with the first contractor, a request to search for jobs within a first geographical region; in response to receiving the request to search for jobs within the first geographical region, receive, from the first user device associated with the first contractor, a request to be hired for the first job position; compare at least a portion of the contractor registration data with at least a portion of the first job position data; in response to receiving the request to be hired for the first job position and in response to comparing at least the portion of the contractor registration data with at least the portion of the first job position data, send, to the second user device associated with the first employer, a request to hire the first contractor for the first job position; receive, from the second user device associated with the first employer, an acceptance of the request to hire the first contractor for the first job position; in response to receiving the acceptance of the request to hire the first contractor for the first job position, initiate payment of at least one insurance premium based at least on the job acceptance data which include address of work, rate of pay, duration of assignment, etc.

In some embodiments, the one or more processors can be configured to perform any processes or subprocesses disclosed herein.

In some embodiments, a method for connecting contractors to employers can include receiving, from a first user device associated with a first contractor, contractor registration data of the first contractor, the contractor registration data including first contractor location data and first job experience data; querying one or more state license databases to verify at least a portion of the contractor registration data; querying one or more background check databases based at least on the contractor registration data to determine that no criminal record data was found for the first contractor; receiving, from a second user device associated with a first employer, first job position data including first job location data, first job compensation data, and first job requirement data for a first job position; receiving, from the first user device associated with the first contractor, a request to search for jobs within a first geographical region; in response to receiving the request to search for jobs within the first geographical region, receiving, from the first user device associated with the first contractor, a request to be hired for the first job position; comparing at least a portion of the contractor registration data with at least a portion of the first job position data; in response to receiving the request to be hired for the first job position and in response to comparing at least the portion of the contractor registration data with at least the portion of the first job position data, sending, to the second user device associated with the first employer, a request to hire the first contractor for the first job position; receiving, from the second user device associated with the first employer, an acceptance of the request to hire the first contractor for the first job position; in response to receiving the acceptance of the request to hire the first contractor for the first job position, initiating payment of at least one insurance premium based at least on the job acceptance data.

In some embodiments, the method can include any processes or subprocesses disclosed herein.

In some embodiments, the method performed by the one or more processors can include any processes or subprocesses disclosed herein.

### BRIEF DESCRIPTION OF THE DRAWINGS

A complete understanding of the present features or aspects and the advantages and features thereof will be more readily understood by reference to the following detailed description when considered in conjunction with the accompanying drawings wherein:

FIG. 1 illustrates a block diagram of a system for connecting contractors to employers, according to some embodiments disclosed herein;

FIG. 2 illustrates a block diagram of a computing device for connecting contractors to employers, according to some embodiments disclosed herein;

FIG. 3 illustrates an example information flow diagram of a process for connecting contractors to employers, according to some embodiments disclosed herein;

FIGS. 4-6 illustrate a user interface generated for connecting contractors to employers, according to some embodiments disclosed herein;

FIG. 7 illustrates an example flow diagram of a process for connecting contractors to employers, according to some embodiments disclosed herein;

FIG. 8 illustrates an example flow diagram of a process for registering employers, according to some embodiments disclosed herein;

FIG. 9 illustrates an example flow diagram of a process for reporting employment data, according to some embodiments disclosed herein;

FIG. 10 illustrates an example flow diagram of a process for recommending compensation amounts and generating tax forms, according to some embodiments disclosed herein; and

FIG. 11 illustrates an example flow diagram of a process for utilizing a machine learning model, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

Any specific details of features or aspects are used for demonstration purposes only, and no unnecessary limitations or inferences are to be understood therefrom.

Before describing in detail exemplary aspects, it is noted that the aspects reside primarily in combinations of components and procedures related to the systems, methods, and media disclosed herein. Accordingly, the systems, methods, and media components and processes have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship, or order between such entities or elements. Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary aspects of the inventive concepts defined in the appended claims. Hence, specific steps, process order, dimensions, component connections, and other physical characteristics relating to the aspects disclosed herein are not to be considered as limiting, unless the claims expressly state otherwise. The use or mention of any single element contemplates a plurality of such element, and the use or mention of a plurality of any element contemplates a single element (for example, “a device” and “devices” and “a plurality of devices” and “one or more devices” and “at least one device” contemplate each other), regardless of whether particular variations are identified and/or described, unless impractical, impossible, or explicitly limited.

Mechanisms (which can include systems, methods, media, or any combination thereof), for connecting contractors to employers are disclosed herein.

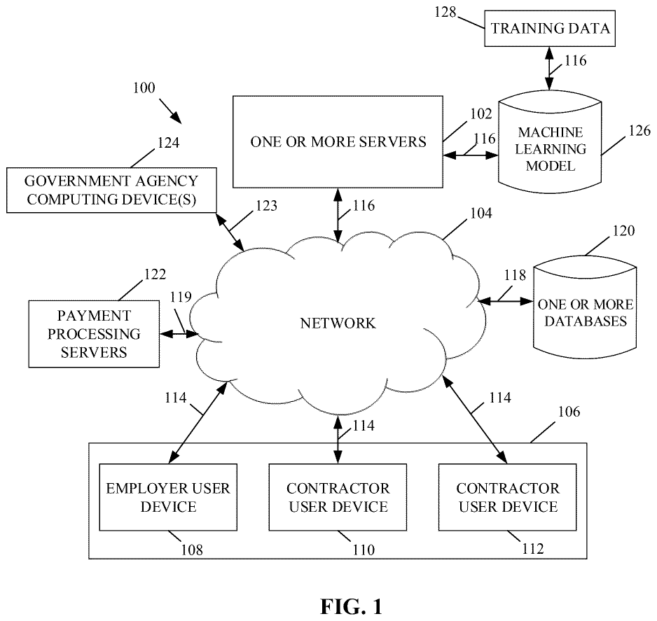

Referring to FIG. 1, a system 100 for connecting contractors to employers can be used with some embodiments disclosed herein. In some embodiments, system 100 can comprise one or more servers 102, a network 104 (e.g., communication network), one or more user devices 106, at least one payment processing server 122, one or more databases 120, at least one government agency computing device 124, or any combination thereof. In some embodiments, the one or more user devices 106 can include a first employer user device 108, a second contractor user device 110, a third contractor user device 112, any other user device(s), or any combination thereof.

The one or more servers 102 can be any suitable server(s) for storing data, programs, or a combination thereof, for connecting contractors to employers. In some embodiments, the one or more servers 102 can store any suitable data about user accounts (e.g., contractor accounts, employer accounts, administrator accounts, etc.). For example, the one or more servers 102 can store data indicating at least: authentication credentials for any user accounts, location history of any user devices, the number of hours worked by any contractor during any period of time, the job position history of any contractor, payment history from any employer to any contractor, any other suitable data, or any combination thereof.

In some embodiments, the one or more servers 102 can include one or more computing devices. While the one or more servers 102 are illustrated as one device, the processes performed by the one or more servers 102 can be performed by any suitable number of computing devices in some embodiments.

The one or more user devices 106 can be any suitable user device(s) for storing data, programs, or a combination thereof, for connecting contractors to employers. In some embodiments, the one or more user devices 106 can store any suitable data about user accounts (e.g., contractor accounts, employer accounts). For example, the one or more user devices 106 can store data indicating at least: location history of any user devices, the number of hours worked by any contractor during any period of time, the job position history of any contractor, payment history from any employer to any contractor, any other suitable data, or any combination thereof.

In some embodiments, the one or more user devices 106 can include one or more computing devices. Although three user devices 108, 110, 112 are shown in FIG. 1 to avoid over-complicating the figure, any suitable number of user devices (e.g., employer user devices, contractor user devices) can be used in some embodiments.

The at least one payment processing server 122 can include any suitable servers that process payment transactions initiated by the one or more servers 102. For example, the at least one payment processing server 122 can include a bank server, a credit card payment processing server, any other suitable server that processes payment transactions, or any combination thereof.

The one or more databases 120 can include any suitable databases that store any suitable license data for any contractors, background check data for any person, or any combination thereof.

The at least one government agency computing device 124 can include any computing devices that are operated by at least one government agency. The at least one government agency computing device 124 can include any computing devices that are suitable for storing data about any contractors, including data indicating the number of hours worked by any contractor during any period of time, the job position history of any contractor, payment history from any employer to any contractor, any other suitable data, or any combination thereof.

The network 104 can include a wired network, a wireless network, or a combination thereof. In some embodiments, the network 104 can include the Internet, an intranet, a wide-area network (WAN), a local-area network (LAN), a digital subscriber line (DSL) network, a frame relay network, an asynchronous transfer mode (ATM) network, a virtual private network (VPN), any other suitable communication network, or any combination thereof. In some embodiments, one or more communications links 114 can connect the one or more user devices 106 to the network 104. In some embodiments, one or more communication links 116 can connect the one or more servers 102 to the network 104 and to a machine learning model 126. In some embodiments, one or more communication links 118 can connect the network 104 to the one or more databases 120. In some embodiments, one or more communication links 119 can connect the network 104 to the at least one payment processing server 122. In some embodiments, one or more communication links 123 can connect the network 104 to the at least one government agency computing device 124.

In some embodiments, the one or more communication links 114, 116, 118, 119, 123 can include any communication links suitable for communicating information between any devices of the one or more user devices 106, the one or more servers 102, the one or more databases 120, the at least one payment processing server 122, the at least one government agency computing device 124, and computing device 124. For example, the one or more communication links 114, 116, 118, 119, 123 can include network links, dial-up links, wireless links, hard-wired links, any other suitable communications links, or any combination thereof.

In some embodiments, the one or more servers 102, the one or more user devices 106, the at least one payment processing server 122, and the at least one government agency computing device 124 can be implemented using any suitable hardware. For example, any device of the one or more servers 102, the one or more user devices 106, the at least one payment processing server 122, and the at least one government agency computing device 124 can be implemented using any suitable general-purpose computer or special-purpose computer. Any general-purpose computer or special-purpose computer can include any suitable hardware.

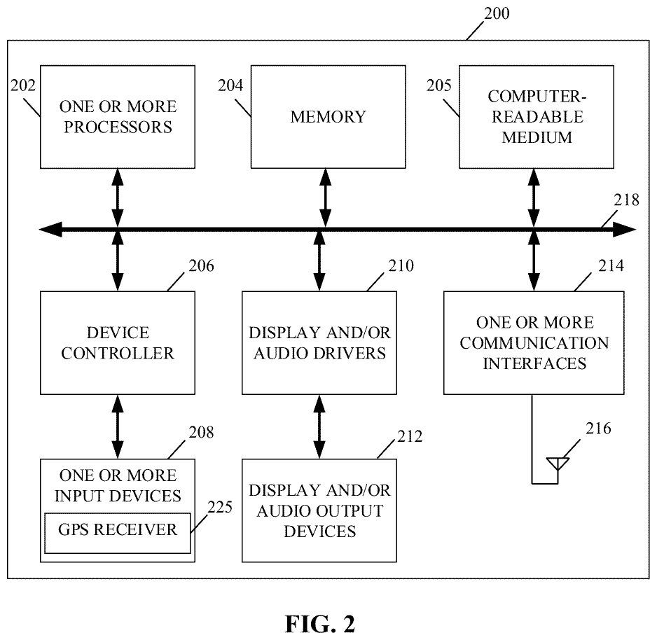

Referring to FIG. 2, an example hardware of a computing device 200 is illustrated. In some embodiments, the computing device 200 can include one or more processors 202, memory 204, a device controller 206, one or more input devices 208, display and/or audio drivers 210, display and/or audio output devices 212, one or more communication interfaces 214, one or more antennas 216, a bus 218, or any combination thereof.

In some embodiments, the one or more processors 202 can include any suitable hardware processor, such as a central processing unit (CPU), a graphics processing unit (GPU), a tensor processing unit (TPU), an accelerated processing unit (APU), any other type of processing unit, or any combination thereof. In some embodiments, the one or more processors 202 can include a microprocessor, a micro-controller, a digital signal processor, dedicated logic, an application-specific integrated circuit (ASIC), a field programmable gate array (FPGA), an accelerator (e.g., an artificial intelligence (AI) accelerator or a cryptographic accelerator), any other suitable circuitry for controlling the functioning of a general purpose computer or a special purpose computer, or any combination thereof.

In some embodiments, one or more processors 202 of any server of the one or more servers 102 can be controlled by a server program stored in memory 204 of the server. For example, in some embodiments, the server program can cause the one or more processors 202 to perform any process or subprocess disclosed herein.

In some embodiments, one or more processors 202 of any user device (e.g., 108, 110, 112 in FIG. 1) of the one or more user devices 106 can be controlled by a computer program stored in memory 204 of the user device. For example, the computer program can cause the one or more processors 202 to perform any process or subprocess disclosed herein.

In some embodiments, the memory 204 can include any suitable memory, storage, or a combination thereof for storing programs, data, and/or any other suitable information. For example, memory 204 can include volatile memory, non-volatile memory, or any combination thereof. In some embodiments, memory 204 can include random access memory, read-only memory, flash memory, a hard disk drive, a solid state drive, optical media, any other suitable memory, or any combination thereof.

In some embodiments, computer-readable media 205 can be operably coupled to the one or more processors 202. In some embodiments, the computer-readable media 205 can store instructions that, when executed by the one or more processors 202, cause the one or more processors 202 to perform any process or subprocess disclosed herein. In some embodiments, computer readable media 205 can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In some embodiments, the device controller 206 can include any suitable processor or circuitry for controlling and receiving any input from the one or more input devices 208. In some embodiments, the one or more input devices 208 can include a touchscreen, a keyboard, a mouse, one or more buttons, a voice recognition circuit, a camera, one or more sensors, a global positioning system (GPS) receiver 225, any other suitable input device, or any combination thereof. In some embodiments, the one or more sensors can include one or more accelerometers, one or more gyroscope sensors, one or more microphones, any other suitable sensors (e.g., an optical sensor, a temperature sensor, a near field sensor), or any combination thereof.

The GPS receiver 225 can be configured to receive any signals from GPS satellites so that the computing device 200 can determine geographical location information of the computing device 200 using, for example, multilateration (including e.g., trilateration). The signals from the GPS satellites can contain information about the satellites' positions and the times at which the signals were sent which can be used to determine the geographical location information of the computing device 200. In some embodiments, the one or more input devices 208 can be included in any device of the one or more servers 102, the one or more user devices 106, or any combination thereof.

In some embodiments, the display and/or audio drivers 210 can include any suitable circuitry for controlling and driving output to one or more display and/or audio output devices 212. For example, the output devices can include a display (e.g., including a touchscreen, a flat-panel display, a cathode ray tube display, a projector, any other suitable display or presentation device, or any combination thereof), one or more speakers, or a combination thereof.

In some embodiments, the one or more communication interfaces 214 can include any suitable circuitry for interfacing with one or more communication networks, such as network 104 as shown in FIG. 1. For example, the one or more communication interfaces 214 can include network interface card circuitry, wired communication circuitry, wireless communication circuitry, any other suitable communication network circuitry, or any combination thereof.

In some embodiments, the one or more antennas 216 can wirelessly communicate with a communication network (e.g., network 104). In some embodiments, the one or more antennas 216 can be omitted.

In some embodiments, the bus 218 can include any suitable communication system for communicating data, addresses, control signals, power, or any combination thereof, between two or more components 202, 204, 205, 206, 210, and 214. In some embodiments, the bus 218 can include any suitable conductors that are constructed and arranged to communicate data, addresses, control signals, power, or any combination thereof, between two or more components 202, 204, 205, 206, 210, and 214.

In some embodiments, any other suitable component(s) can be included in the computing device 200.

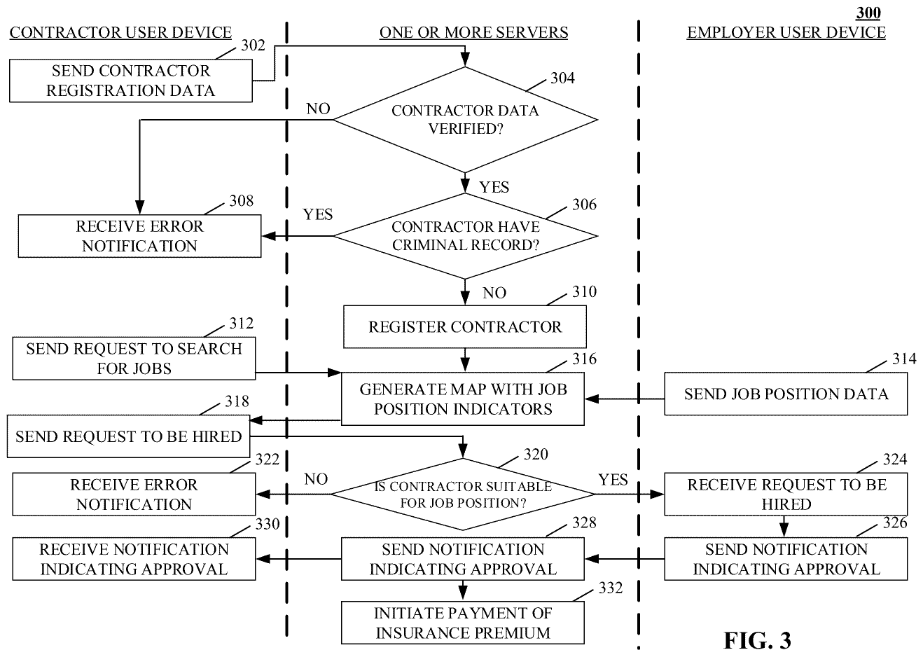

Referring to FIG. 3, an example information flow diagram of a process 300 for connecting contractors to employers is shown according to some embodiments disclosed herein. In some embodiments, blocks of process 300 can be implemented on computing devices such as one or more servers (e.g., 102 in FIG. 1), at least one contractor user device (e.g., 110, 112 in FIG. 1), and at least one employer user device (e.g., 108 in FIG. 1).

At 302, the at least one contractor user device can send contractor registration data to one or more servers. In response, the one or more servers can receive from the at least one contractor user device, the contractor registration data of a contractor. The contractor registration data can include first contractor location data and first job experience data.

At 304, the one or more servers can query one or more state license databases (e.g., 120 in FIG. 1) to verify at least a portion of the contractor registration data. At 306, after verifying the contractor registration data, the one or more servers can query one or more background check databases (e.g., 120 in FIG. 1) based at least on the contractor registration data to determine if the contractor has a criminal record. If the contractor is determined not to have a criminal record, the one or more servers can register the contractor at 310. Otherwise, if the contractor registration data is not verified, or if the contractor is determined to have a criminal record, the one or more servers can send an error notification to the contractor user device at 308, the notification indicating that the contractor cannot be registered and the reason for not registering the contractor.

At 314, at least one employer user device can send job position data to the one or more servers, the job position data including first job location data, first job compensation data, and first job requirement data for a first job position.

At 312, the at least one contractor user device can send a request to search for jobs within a first geographical region to the one or more servers. The one or more servers can receive from the contractor user device, the request to search for jobs within the first geographical region.

At 316, the one or more servers can generate a map with position indicators thereon, the position indicators indicating geographical locations of a plurality of contractor user devices within the first geographical region, the plurality of contractor user devices including the contractor user device.

At 318, the at least one contractor user device can send a request to be hired for the first job position to the one or more servers. The one or more servers can receive from the at least one contractor user device, the request to be hired for the first job position.

At 320, the one or more servers can compare at least a portion of the contractor registration data with at least a portion of the first job position data to determine if the contractor is suitable for the first job position.

At 324, if the contractor is determined to be suitable for the first job position, the one or more servers can send the request to hire the contractor to the employer user device, and the employer user device can receive the request. If the employer indicates approval on the employer user device, the employer can send the notification indicating approval of the request to the one or more servers at 326.

At 328, the one or more servers can send the notification indicating approval of the request to the contractor user device, and at 330 the contractor user device can receive the notification.

At 332, the one or more servers can initiate payment of at least one insurance premium by communicating with a payment processing server (e.g., 122 in FIG. 1). The job acceptance data (e.g., address of work, rate of pay, duration of assignment, etc.) may be used in addition to any information needed in order to purchase workers compensation insurance and file a 1099 at the end of each year.

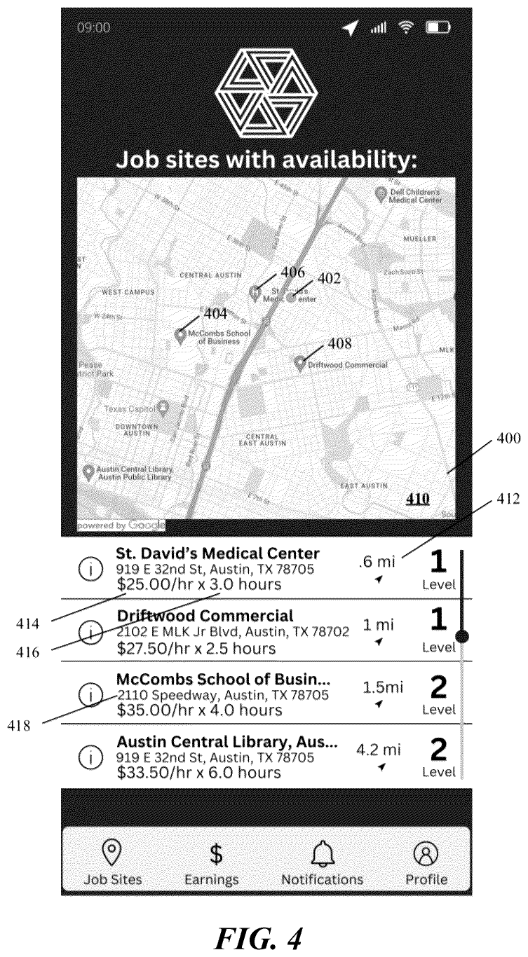

Referring to FIG. 4, a user interface 400 can include a map 401 and position indicators 402, 404, 406, 408 thereon generated at a user interface of a contractor user device (e.g., 110, 112 in FIG. 1). The map 401 can represent a geographical area 410, and can include any suitable geographical features, structures, landmarks, etc. In some embodiments, at least one positional indicator 402 can indicate at least an approximate location of a contractor user device that generated the user interface 400. In some embodiments, the position indicators 404, 406, 408 can indicate at least approximate job locations indicated by corresponding employer user devices (e.g., 108 in FIG. 1). The at least approximate locations can be determined using any suitable method or system, such as, for example, a global positioning system (GPS), multilateration, cellular triangulation, Wi-Fi positioning, internet protocol geolocation, etc.

The user interface 400 can further include a ranked list of job positions, wherein the job positions are ranked based on job location distance to the contractor user device. The user interface 400 can further indicate the job location distance 412 from the contractor user device to each job location. The user interface 400 can further indicate a compensation amount 414 and number of hours 416 to be worked for each job position. The user interface 400 can further indicate a company name and address 418 associated with each job position.

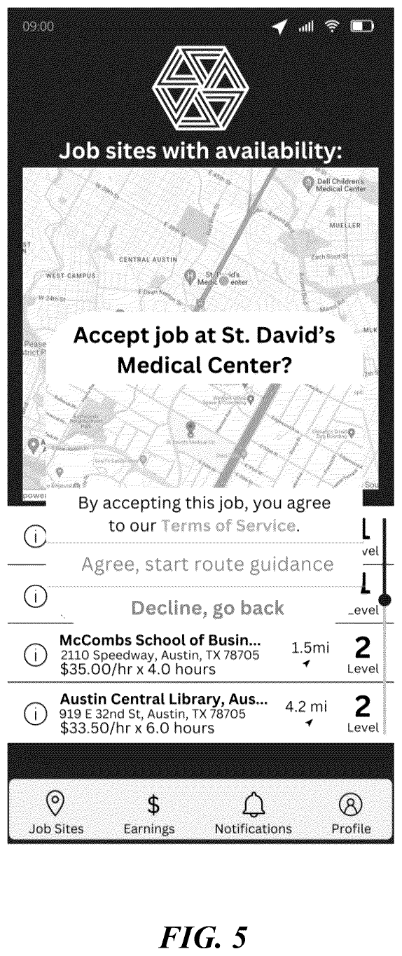

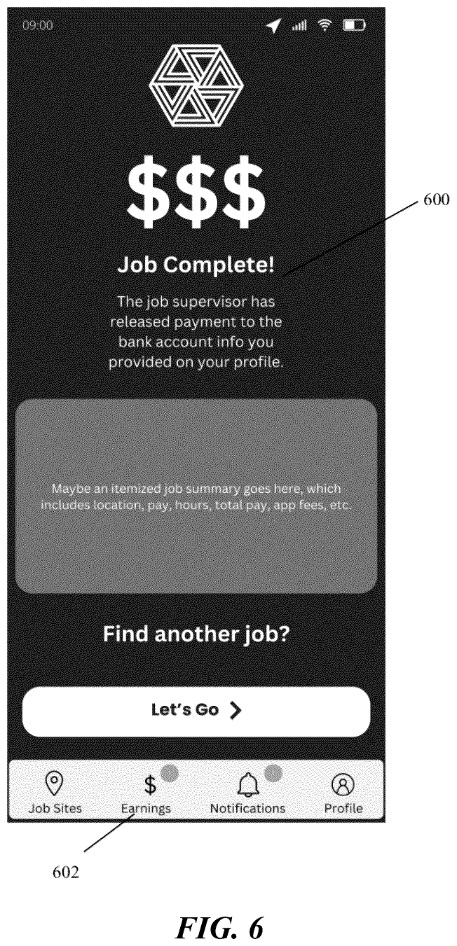

Referring to FIG. 5, the user interface 400 can receive a selection of a job position at a contractor user device, and in response, request confirmation of the acceptance of the job position. Referring to FIG. 6, after a job position is completed, the user interface 400 can provide a notification 600 indicating that payment has been initiated by the employer user device. In some embodiments, the user interface 400 can include a selectable icon 602 for earnings that, when selected, prompts the user interface 400 to present historical earnings data for the contractor.

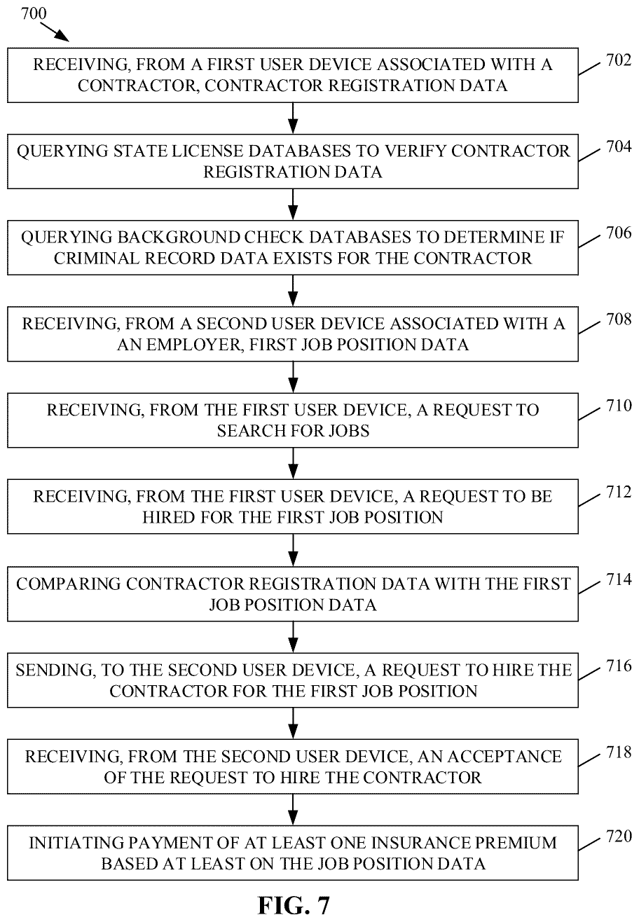

Referring to FIG. 7, a flow diagram of a process 700 for connecting contractors to employers is shown. At 702, the process can include receiving from a first user device associated with a first contractor, contractor registration data of the first contractor, the contractor registration data including first contractor location data and first job experience data.

At 704, the process 700 can include querying one or more state license databases to verify at least a portion of the contractor registration data.

At 706, the process 700 can include querying one or more background check databases based at least on the contractor registration data to determine that no criminal record data was found for the first contractor.

At 708, the process 700 can include receiving from a second user device associated with a first employer, first job position data including first job location data, first job compensation data, and first job requirement data for a first job position.

At 710, the process 700 can include receiving from the first user device associated with the first contractor, a request to search for jobs within a first geographical region.

At 712, the process 700 can include in response to receiving the request to search for jobs within the first geographical region, receiving, from the first user device associated with the first contractor, a request to be hired for the first job position.

At 714, the process 700 can include comparing at least a portion of the contractor registration data with at least a portion of the first job position data.

At 716, the process 700 can include in response to receiving the request to be hired for the first job position and in response to comparing at least the portion of the contractor registration data with at least the portion of the first job position data, sending, to the second user device associated with the first employer, a request to hire the first contractor for the first job position.

At 718, the process 700 can include receiving from the second user device associated with the first employer, an acceptance of the request to hire the first contractor for the first job position.

At 720, the process 700 can include in response to receiving the acceptance of the request to hire the first contractor for the first job position, initiating payment of at least one insurance premium based at least on the job position data.

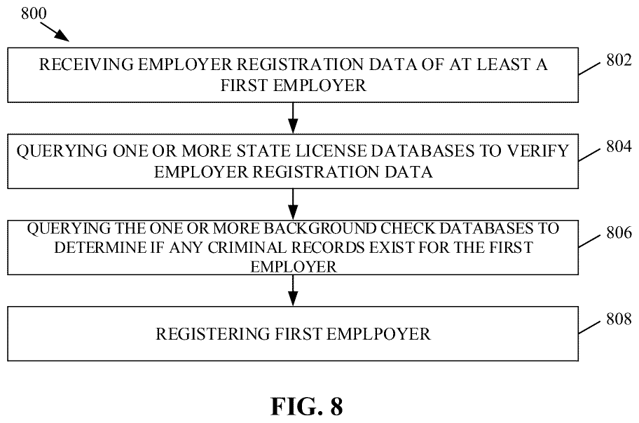

Referring to FIG. 8, a flow diagram of a process 800 for registering employers is shown. At 802, the process 800 can include receiving employer registration data of at least a first employer.

At 804, the process 800 can include querying one or more state license databases to verify at least a portion of the employer registration data;

At 806, the process 800 can include querying the one or more background check databases to determine if any criminal records exist associated with at least the first employer exist based at least on the employer registration data.

At 808, the process 800 can include registering the first employer if the employer registration data is verified (e.g., matches the data in the one or more state license databases), and if the first employer has no criminal incidents recorded.

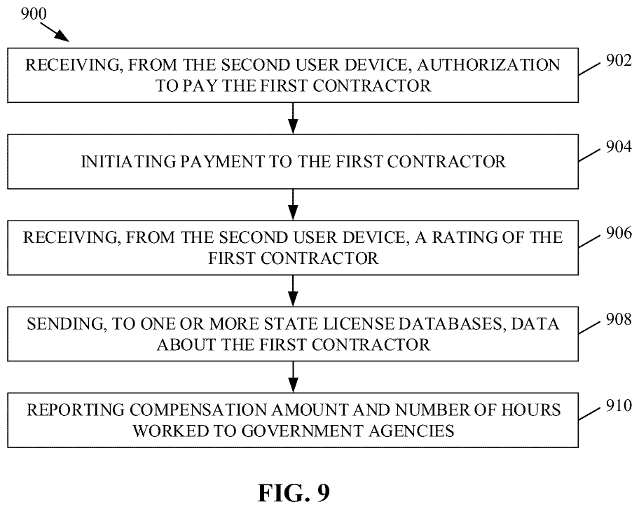

Referring to FIG. 9, a flow diagram of a process 900 for reporting employment data is shown. At 902, the process 900 can include receiving from the second user device associated with the first employer, authorization to pay the first contractor for completing tasks associated with the first job position.

At 904, the process 900 can include initiating payment from a first financial account associated with the first employer to a second financial account associated with the first contractor.

At 906, the process 900 can include receiving from the second user device associated with the first employer, a rating of the first contractor.

At 908, the process 900 can include sending, to one or more state license databases, data about hours worked by the first contractor and at least a second portion of the contractor registration data.

At 910, the process 900 can include reporting a compensation amount and number of hours worked by the first contractor to government agencies by sending any suitable data to government agency computing devices (e.g., 124 in FIG. 1). In some embodiments, the process 900 create daily reports and logs, check/verify all payments against certified payrolls, run certified payrolls, initiate any suitable payments to contractors, comply with SOC2 Type II certification and NIST 800-171 compliance, report on DEI initiatives, submit reports to any suitable government agencies, perform any suitable validation checks required, or any combination thereof. On a weekly basis, the process 900 can include reporting to any suitable government agencies: the name and address of the contractor or subcontractor, the payroll number and the work week ending date, the project name and location, the project or contract number, the name and identification number of each worker, the work classification (type of work) and hourly rate of each worker, the number of hours worked and the gross amount of wages paid to each worker, the deductions and net wages paid to each worker, the fringe benefits paid to each worker or to a plan, fund, or program, a statement of compliance signed by the contractor or subcontractor, or any combination thereof.

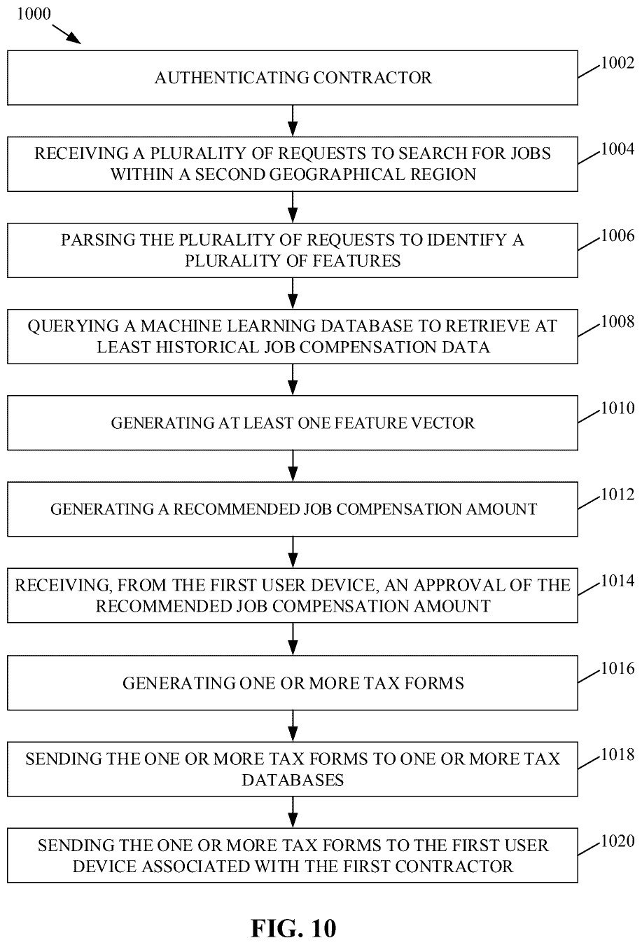

Referring to FIG. 10, a flow diagram of a process 1000 for recommending compensation amounts and generating tax forms is shown.

At 1002, the process 1000 can include authenticating a contractor. For example, the process 100 can include using facial recognition to authenticate a user such as a contractor. In some embodiments, an avatar can be generated for authentication, and recognized facial features can be used to generate the avatar for authentication.

At 1004, the process 1000 can include receiving a plurality of requests to search for jobs within a second geographical region that includes at least a portion of the first geographical region.

At 1006, the process 1000 can include parsing the plurality of requests to identify a plurality of features.

At 1008, the process 1000 can include querying a machine learning database (e.g., included in one or more databases 120 in FIG. 1) to retrieve at least historical job compensation data associated with the second geographical region.

At 1010, the process 1000 can include generating at least one feature vector based at least on the plurality of features and the historical job compensation data associated with the second geographical region.

At 1012, the process 1000 can include providing the at least one feature vector to a machine learning model (e.g., 126 in FIG. 1) that is configured to generate a recommended job compensation amount.

At 1014, the process 1000 can include sending to the first user device associated with the first contractor, a request for approval of the recommended job compensation amount. In response, the process 1000 can include receiving from the first user device associated with the first contractor, an approval of the recommended job compensation amount.

At 1016, the process 1000 can include generating one or more tax forms based at least on the approved recommended compensation amount.

At 1018, the process 1000 can include sending the one or more tax forms to one or more tax databases (e.g., included in one or more databases 120 in FIG. 1) for the reporting of income of the first contractor.

At 1020, the process 1000 can include sending the one or more tax forms to the first user device associated with the first contractor.

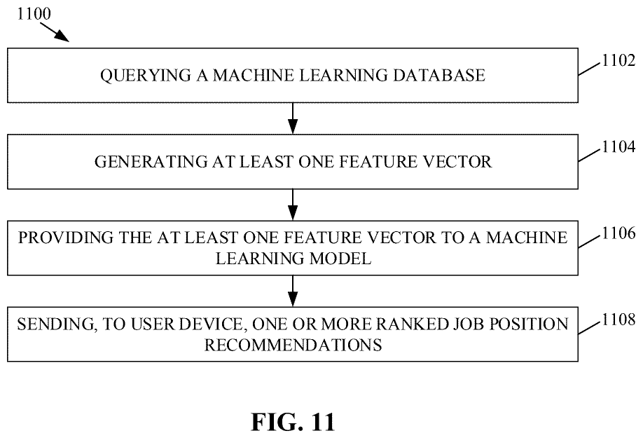

Referring to FIG. 11, a flow diagram of a process 1100 for utilizing a machine learning model (e.g., 126 in FIG. 1) is shown. At 1102, the process 1100 can include querying a machine learning database to retrieve at least historical job compensation data associated with a plurality of contractors that includes a first contractor, and historical job rating data.

At 1104, the process 1100 can include generating at least one feature vector based at least on the historical job rating data and the historical job compensation data.

At 1106, the process 1100 can include providing the at least one feature vector to a machine learning model that is configured to generate one or more ranked contractor recommendations for the first employer.

At 1108, the process 1100 can include sending to the second user device associated with the first employer, the one or more ranked contractor recommendations.

In some embodiments, the machine learning model (e.g., 126 in FIG. 1) can be trained using any suitable data such as, for example, historical job position data, contractor feedback data, employer feedback data, ratings data, any other suitable data, or any combination thereof.

It will be understood that it would be unduly repetitious and obfuscating to describe and illustrate every reordering, combination and subcombination of the elements and the aspects described. Accordingly, all elements, processes, and subprocesses can be combined in any way and/or combination, and the present specification, including the drawings, shall be construed to constitute a complete written description of all reorderings, combinations and subcombinations of the elements, processes, and subprocesses and of the aspects described herein, and of the manner and process of making and using the elements, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for connecting contractors to employers, comprising:
receiving, from a first user device associated with a first contractor, contractor registration data of the first contractor, the contractor registration data including first contractor location data and first job experience data;
querying one or more state license databases to verify at least a portion of the contractor registration data;
querying one or more background check databases based at least on the contractor registration data to determine that no criminal record data was found for the first contractor;
receiving, from a second user device associated with a first employer, first job position data including first job location data, first job compensation data, and first job requirement data for a first job position;
receiving, from the first user device associated with the first contractor, a request to search for jobs within a first geographical region;
in response to receiving the request to search for jobs within the first geographical region, determining, via a global positioning system (GPS) receiver of the first user device, real-time geographical location data of the first user device using multilateration of signals received from GPS satellites;
generating a graphical map interface representing the first geographical region, the graphical map interface including a first position indicator indicating the real-time geographical location of the first user device and a plurality of additional position indicators indicating geographical locations of a plurality of job positions within the first geographical region, wherein the plurality of job positions includes the first job position;
transmitting the graphical map interface to the first user device for display;
receiving, from the first user device associated with the first contractor, a request to be hired for the first job position based on a selection of one of the plurality of additional position indicators on the graphical map interface;
comparing at least a portion of the contractor registration data with at least a portion of the first job position data;
in response to receiving the request to be hired for the first job position and in response to comparing at least the portion of the contractor registration data with at least the portion of the first job position data, sending, to the second user device associated with the first employer, a request to hire the first contractor for the first job position;
receiving, from the second user device associated with the first employer, an acceptance of the request to hire the first contractor for the first job position;
in response to receiving the acceptance of the request to hire the first contractor for the first job position, initiating payment of at least one insurance premium based at least on the first job position data.

2. The method of claim 1, wherein the contractor registration data of at least the first contractor includes social security data of at least the first contractor.

3. The method of claim 1, wherein the contractor registration data of at least the first contractor includes state license data of at least the first contractor.

4. The method of claim 1, wherein the contractor registration data of at least the first contractor includes hours reported by at least the first contractor.

5. The method of claim 1, further comprising:
receiving employer registration data of at least a first employer;
querying one or more state license databases to verify at least a portion of the employer registration data;
querying the one or more background check databases to determine if any criminal records exist associated with at least the first employer exist based at least on the employer registration data.

6. The method of claim 1, wherein the job requirement data indicates an amount of experience required, required working dates, and job task data.

7. The method of claim 1, further comprising:
receiving, from the second user device associated with the first employer, authorization to pay the first contractor for completing tasks associated with the first job position.

8. The method of claim 7, further comprising:
initiating payment from a first financial account associated with the first employer to a second financial account associated with the first contractor.

9. The method of claim 1, further comprising:
receiving, from the second user device associated with the first employer, a rating of the first contractor.

10. The method of claim 1, further comprising:
sending, to one or more state license databases, data about hours worked by the first contractor and at least a second portion of the contractor registration data.

11. The method of claim 1, further comprising:
receiving a plurality of requests to search for jobs within a second geographical region that includes at least a portion of the first geographical region;
parsing the plurality of requests to identify a plurality of features;
querying a machine learning database to retrieve at least historical job compensation data associated with the second geographical region;
generating at least one feature vector based at least on the plurality of features and the historical job compensation data associated with the second geographical region;
providing the at least one feature vector to a machine learning model that is configured to generate a recommended job compensation amount by processing the at least one feature vector through one or more trained neural network layers;
sending, to the first user device associated with the first contractor, a request for approval of the recommended job compensation amount;
receiving, from the first user device associated with the first contractor, an approval of the recommended job compensation amount.

12. The method of claim 11, further comprising:
generating one or more tax forms based at least on the approved recommended compensation amount;
sending the one or more tax forms to one or more tax databases for the reporting of income of the first contractor;
sending the one or more tax forms to the first user device associated with the first contractor.

13. The method of claim 1, further comprising:
querying a machine learning database to retrieve at least:
historical job compensation data associated with the first contractor;
generating at least one feature vector based at least on the first contractor location data, the first job experience data, and the historical job compensation data;
providing the at least one feature vector to a machine learning model that is configured to generate one or more ranked job position recommendations for the first contractor;
sending, to the first user device associated with the first contractor, the one or more ranked job position recommendations.

14. The method of claim 1, further comprising:
querying a machine learning database to retrieve at least:
historical job rating data associated with a plurality of contractors that includes the first contractor; and
historical job compensation data associated with the plurality of contractors;
generating at least one feature vector based at least on the historical job rating data and the historical job compensation data;
providing the at least one feature vector to a machine learning model that is configured to generate one or more ranked contractor recommendations for the first employer;
sending, to the second user device associated with the first employer, the one or more ranked contractor recommendations.

15. The method of claim 1, further comprising:
determining that a predetermined time period has passed;
in response to determining that the predetermined time period has passed, sending, to one or more computing devices associated with one or more government agencies, at least:
a contractor identifier of the first contractor;
at least the portion of the first job position data, wherein at least the portion of the first job position data indicates a compensation amount paid to the first contractor during the predetermined time period and a number of hours worked by the first contractor during the predetermined time period.

16. The method of claim 1, further comprising:
receiving image data;
performing facial recognition on the image data to identify the first contractor;
in response to performing facial recognition on the image data to identify the first contractor, granting login authentication to log the first contractor into a contractor account associated with the first contractor.

17. The method of claim 1, wherein the first job compensation data includes a first requested compensation amount; wherein the method further comprises:
receiving, from the second user device associated with the first employer, a second requested compensation amount that is different than the first requested compensation amount.

18. A system for connecting contractors to employers, comprising:
memory; and
one or more processors operably coupled to the memory, the one or more processors configured at least to:
receive, from a first user device associated with a first contractor, contractor registration data of the first contractor, the contractor registration data including first contractor location data and first job experience data;
query one or more state license databases to verify at least a portion of the contractor registration data;
query one or more background check databases based at least on the contractor registration data to determine that no criminal record data was found for the first contractor;
receive, from a second user device associated with a first employer, first job position data including first job location data, first job compensation data, and first job requirement data for a first job position;
receive, from the first user device associated with the first contractor, a request to search for jobs within a first geographical region;
in response to receiving the request to search for jobs within the first geographical region, receive, from a global positioning system (GPS) receiver of the first user device, real-time geographical location data of the first user device determined using multilateration of signals received from GPS satellites;
generate a graphical map interface representing the first geographical region, the graphical map interface including a first position indicator indicating the real-time geographical location of the first user device and a plurality of additional position indicators indicating geographical locations of a plurality of job positions within the first geographical region, wherein the plurality of job positions includes the first job position;
transmit the graphical map interface to the first user device for display;
receive, from the first user device associated with the first contractor, a request to be hired for the first job position based on a selection of one of the plurality of additional position indicators on the graphical map interface;
compare at least a portion of the contractor registration data with at least a portion of the first job position data;
in response to receiving the request to be hired for the first job position and in response to comparing at least the portion of the contractor registration data with at least the portion of the first job position data, send, to the second user device associated with the first employer, a request to hire the first contractor for the first job position;
receive, from the second user device associated with the first employer, an acceptance of the request to hire the first contractor for the first job position;
in response to receiving the acceptance of the request to hire the first contractor for the first job position, initiate payment of at least one insurance premium based at least on the first job position data.

19. The system of claim 18, wherein the one or more processors are further configured to:
query a machine learning database to retrieve at least:
historical job compensation data associated with the first contractor;
generate at least one feature vector based at least on the first contractor location data, the first job experience data, and the historical job compensation data;
provide the at least one feature vector to a machine learning model that is configured to generate one or more ranked job position recommendations for the first contractor;
send, to the first user device associated with the first contractor, the one or more ranked job position recommendations.

20. A non-transitory computer-readable medium comprising instructions, that when executed by one or more processors, cause the one or more processors to perform a method for connecting contractors to employers, the method comprising:
receiving, from a first user device associated with a first contractor, contractor registration data of the first contractor, the contractor registration data including first contractor location data and first job experience data;
querying one or more state license databases to verify at least a portion of the contractor registration data;
querying one or more background check databases based at least on the contractor registration data to determine that no criminal record data was found for the first contractor;
receiving, from a second user device associated with a first employer, first job position data including first job location data, first job compensation data, and first job requirement data for a first job position;
receiving, from the first user device associated with the first contractor, a request to search for jobs within a first geographical region;
in response to receiving the request to search for jobs within the first geographical region, determining, via a global positioning system (GPS) receiver of the first user device, real-time geographical location data of the first user device using multilateration of signals received from GPS satellites;
generating a graphical map interface representing the first geographical region, the graphical map interface including a first position indicator indicating the real-time geographical location of the first user device and a plurality of additional position indicators indicating geographical locations of a plurality of job positions within the first geographical region, wherein the plurality of job positions includes the first job position;
transmitting the graphical map interface to the first user device for display;
receiving, from the first user device associated with the first contractor, a request to be hired for the first job position based on a selection of one of the plurality of additional position indicators on the graphical map interface;
comparing at least a portion of the contractor registration data with at least a portion of the first job position data;
in response to receiving the request to be hired for the first job position and in response to comparing at least the portion of the contractor registration data with at least the portion of the first job position data, sending, to the second user device associated with the first employer, a request to hire the first contractor for the first job position;
receiving, from the second user device associated with the first employer, an acceptance of the request to hire the first contractor for the first job position;
in response to receiving the acceptance of the request to hire the first contractor for the first job position, initiating payment of at least one insurance premium based at least on the first job position data.
